(19) United States
(12) Patent Application Publication
(10) Pub. No.: US 2007/0200921 A1
(43) Pub. Date: Aug. 30, 2007

(54) Electronic conference system and method thereof and conference participant terminal device, computer data signal

(76) Inventor: Kazunori Horikiri, Tokyo (JP)

Correspondence Address: GAUTHIER & CONNORS, LLP, 225 FRANKLIN STREET, SUITE 2300, BOSTON, MA, 02110, US

(21) Appl. No.: 11/520,315

(22) Filed: Sep. 13, 2006

(30) Foreign Application Priority Data
Feb. 9, 2006 (JP) 2006-033073

(51) Int. Cl. H04N 7/14

(52) U.S. Cl. 348/14.08

(57) ABSTRACT

There is provided an electronic conference system, including a presenter terminal device that displays on a screen of a presenter display in an electronic conference, a conference participant terminal device that receives a screen image displayed on the presenter display and displays the screen image on a screen, a receiving unit that receives the screen image sent from the presenter terminal device, and a storage processing unit that writes a currently displayed screen image in a memory, when a screen image which is different from the currently displayed screen image has not been sent from the presenter terminal device within a predetermined time.

### BACKGROUND

1. Technical Field

The present invention generally relates to an electronic conference system having a presenter terminal device used by a presenter and a conference participant terminal device which is used by a participant individually and displays a screen image displayed on the presenter terminal device on a screen, and more particular relates to storage of the screen image at the conference participant terminal device side. And the invention generally relates to a computer data signal embodied in a carrier wave for enabling a computer.

2. Related Art

FIG. 5 is a general configuration diagram of a conventional electronic conference system. FIG. 5 shows an information terminal device (hereinafter referred to as “presenter terminal”) 10 used by a presenter in an electronic conference, plural information terminal devices (hereinafter referred to as “participant terminals”) 40 which are installed in the same conference room with the presenter terminal 10 and used individually by participants in the electronic conference, a user management server 20 which retains and manages information on users participating in the electronic conference, and a document management server 30 which retains and manages screen images such as an electronic document and the like which have been prepared by the presenter or are newly created during the conference, all of which are connected respectively by a LAN 2 which is one form of network. The presenter terminal 10 has a touch panel display device 12 installed so that the participants can refer to display contents such as an electronic whiteboard, for example. An electronic document which has been previously prepared by the presenter is displayed on the touch panel display device 12. The display contents are appropriately switched by the presenter, depending on the progress of the conference. It is also possible for the presenter to write notes, etc. relating to the displayed electronic document. Each participant terminal 40 has an IC card reader 41 which reads an IC card owned by the conference participant, for authenticating the user participating in the conference, and a display 42 on which the display contents on the touch panel display device 12 of the presenter terminal 10 are displayed in real time. Each participant terminal 40 is provided with a note editing function with which the participant can write notes and the like into the display contents on the display 42.

Next, a basic flow of the conference using the electronic conference system will be described.

Each conference participant sits at a predetermined position where the participant terminal 40 is installed in the conference room, and logs in by causing the IC card reader 41 to read his own IC card. The conference participant is thereby confirmed to participate in the conference.

While the presenter in the conference proceeds with the conference, using the presenter terminal 10, the screen image displayed on the touch panel display device 12 of the presenter terminal 10 is sent to each participant terminal 40, and is displayed on each display 42. When the presenter changes material to be displayed on the touch panel display device 12, the screen image of the electronic document newly displayed is sent to each participant terminal 40, and is displayed on the display 42. Moreover, when the presenter writes on the screen image displayed on the touch panel display device 12, the display contents on the touch panel display device 12 are updated, and as a result the written contents are reflected on a screen display on each participant terminal 40 in real time.

While the conference participant participates in the conference, referring to the display contents on the touch panel display device 12 or the display 42, if it is desired to write some sort of note on the displayed screen image, the conference participant uses the note editing function of the participant terminal 40 to write onto the screen image on the display 42. Moreover, if the conference participant hopes to store the displayed screen image in order to study it later or the like, it is possible to retain and manage the displayed screen image individually by depressing a predetermined storage button displayed on the screen.

It should be noted that the screen image newly displayed at the presenter terminal 10 is assigned identification information for identifying each screen image (hereinafter referred to as “screen ID”). The presenter terminal 10 sends the screen image attached with the assigned screen ID to the participant terminal 40.

FIG. 6 is a conceptual diagram showing handling of the screen images in the conventional electronic conference system. As shown in FIG. 6, each time each of the screen images I1 to I5 is newly generated in the presenter terminal 10, the screen image is sent to the participant terminal 40. The participant terminal 40 receives the screen image sent from the presenter terminal 10 and displays it on the screen. Then, if the participant wants to store the displayed screen image, the displayed screen image is stored in a predetermined storage location by performing a predetermined storage operation such as depressing the storage button or the like. In FIG. 6, the screen images I1, I3 and I4-1 are stored in response to user operations.

Moreover, as described above, each participant terminal 40 has the note editing function with which the participant can write notes for the displayed screen image. FIG. 6 shows that a new screen image I4-1 has been generated locally in the participant terminal 40 as a result of notes being written for the screen image I4.

Furthermore, each participant terminal 40 has a function of sending the screen image residing locally to the presenter terminal 10. With this function, it is possible to send the displayed screen image to the presenter terminal 10 by depressing a predetermined sending button displayed on the screen, similarly to a storage function. When the presenter terminal 10 receives the screen image I4-1 sent by the participant terminal 40 using this function, the presenter terminal 10 delivers the screen image I4-1 to each participant terminal 40 used by the conference participant. As a result, it is possible to share the notes written by one conference participant among the other conference participants.

By the way, each participant terminal 40 updates the display contents sequentially with the received screen image. However, it may be inconvenient if the display contents in the participant terminal 40 are updated with the screen image received from the presenter terminal 10 when the conference participant is writing the notes in the displayed screen image by using the note editing function. Therefore, in such a case, updating of the screen is specially suppressed to leave the screen in a still image state, so that it is convenient for the note writing. After the note writing is terminated, the still image state on the display 42 is released when a predetermined time has elapsed since the writing is terminated, and the screen is returned to the real time display of the same screen image as that of the presenter terminal 10.

It should be noted that the display 42 of the participant terminal 40 is provided with a sub screen dedicated to displaying the screen image acquired from the presenter terminal 10, in addition to a main screen which is used for displaying or editing the screen image acquired from the presenter terminal 10 and displays the screen image to be stored. By referring to the display contents on this sub screen, it is possible to confirm the display contents on the presenter terminal 10 even during the note editing.

Moreover, if the screen display is in the still image state and note writing is being performed, even when the most recent screen image is sent from the presenter terminal to the participant terminal, it is not possible to perform an operation such as depressing the storage button and the like. That is, it is not possible to store the screen image while the note editing function is being used. FIG. 7 is a conceptual diagram showing such an inconvenient case. According to FIG. 7, the participant terminal cannot store the screen images I5 and I6 which have been received while the note writing is being performed for the screen image I4.

### SUMMARY

According to an aspect of the invention, there is provided an electronic conference system, including a presenter terminal device that performs display on a screen of a presenter display in an electronic conference, a conference participant terminal device that receives a screen image displayed on the presenter display and displays the screen image on a screen, a receiving unit that receives the screen image sent from the presenter terminal device, and a storage processing unit that writes a currently displayed screen image in a memory, when a screen image which is different from the currently displayed screen image has not been sent from the presenter terminal device within a predetermined time.

### BRIEF DESCRIPTION OF THE DRAWINGS

Embodiment of the present invention will be described in detail based on the following drawings, wherein:

FIG. 1 is a block configuration diagram showing an electronic conference system in this exemplary embodiment;

FIG. 2 is a diagram showing an example of a screen layout displayed on a display of a participant terminal in this exemplary embodiment;

FIG. 3 is a flow chart showing an automatic storage process in this exemplary embodiment;

FIG. 4 is a conceptual diagram showing handling of screen images in this exemplary embodiment;

FIG. 5 is a general configuration diagram of an electronic conference system;

FIG. 6 is a conceptual diagram showing handling of the screen images in a conventional electronic conference system; and

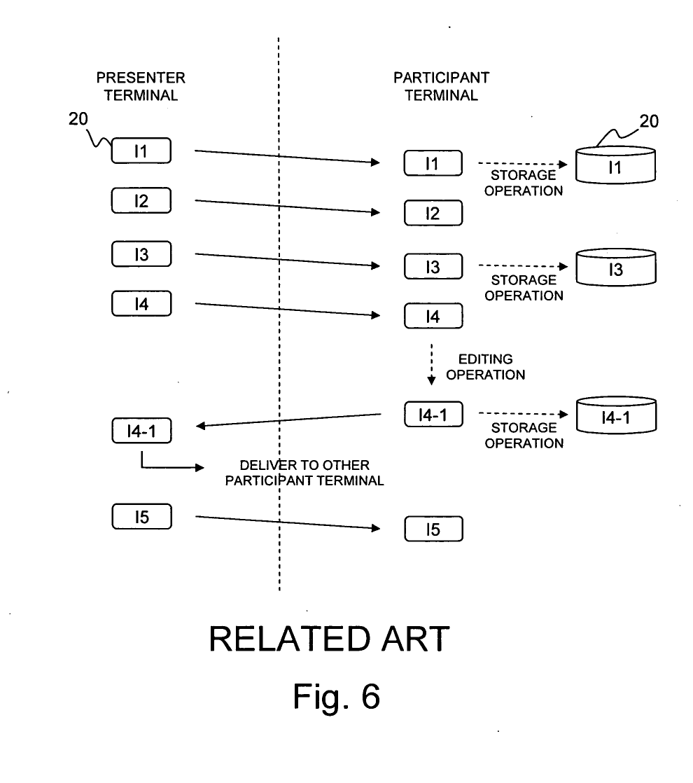

FIG. 7 is a conceptual diagram showing handling of the screen images in the conventional electronic conference system.

### DETAILED DESCRIPTION

An exemplary embodiment of the present invention will be described below based on the drawings.

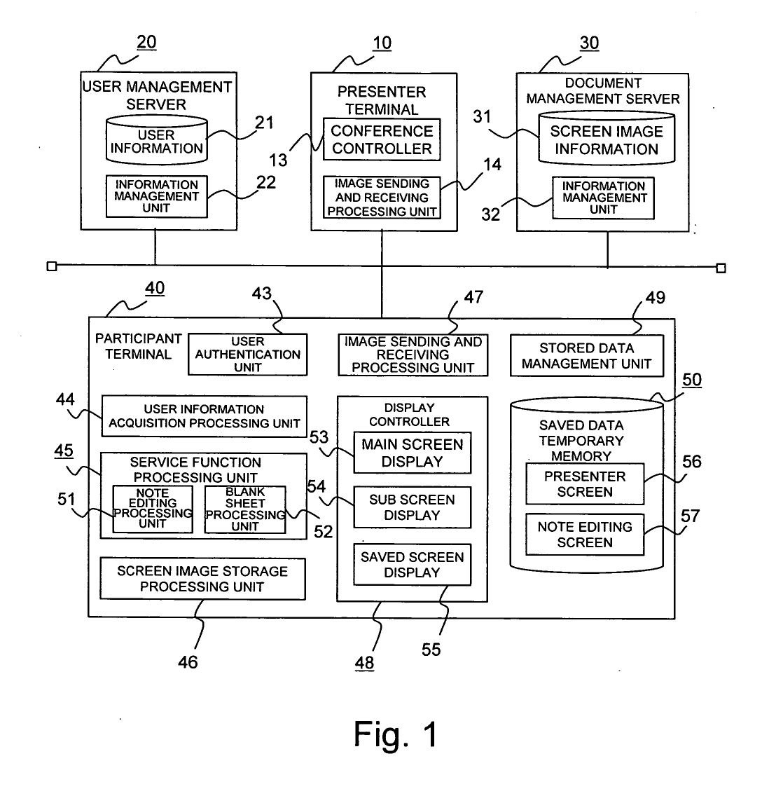

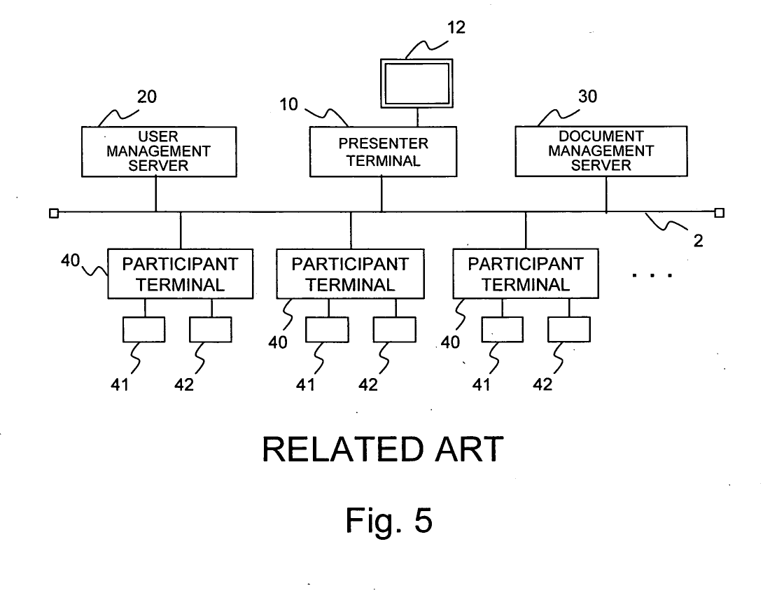

FIG. 1 is a block configuration diagram showing an electronic conference system in this exemplary embodiment. It should be noted that the overall configuration of the electronic conference system may be the same as that of the related art described with FIG. 5. Therefore, the same components are assigned the same reference numerals. FIG. 1 shows a presenter terminal 10, a user management server 20, a document management server 30 and a participant terminal 40, all of which are connected respectively by a LAN 2 which is one form of a network.

The user management server 20 is a server computer that retains and manages information on each user participating in an electronic conference. A user information memory 21 in the user management server 20 stores information required for a user authentication, a storage location of a screen image owned by each user, and the like. An information management unit 22 performs reading user information from the user information memory 21, updating the user information, and furthermore managing and processing the information on the user such as the user authentication and the like, in response to a request from the presenter terminal 10 or the participant terminal 40.

The document management server 30 is a server computer that stores an electronic document owned by each user participating in the electronic conference. A screen image memory 31 in the document management server 30 classifies and stores the screen image, such as the electronic document and the like of each user, for each user. An information management unit 32 performs management of information retained and managed in the screen image memory 31, such as reading the screen image from the screen image memory 31, registering the screen image in the screen image memory 31 and the like, in response to the request from the presenter terminal 10 or the participant terminal 40.

The presenter terminal 10 used by a presenter has a conference controller 13 that controls the entire electronic conference, and a screen image sending and receiving processing unit 14 that sends and receives the screen image, such as delivering the screen image displayed on a touch panel display device 12 only shown in FIG. 5, receiving the screen image sent from the participant terminal 40, and the like.

The participant terminal 40 in this exemplary embodiment has a user authentication unit 43, a user information acquisition processing unit 44, a service function processing unit 45, a screen image storage processing unit 46, an image sending and receiving processing unit 47, a display controller 48, a stored data management unit 49 and a saved data temporary memory 50. The user authentication unit 43 performs the user authentication with respect to a participant in the electronic conference. The user information acquisition processing unit 44 acquires the information on the conference participant from the user management server 20. The service function processing unit 45 executes and controls a service function provided by the electronic conference system in this exemplary embodiment. In this exemplary embodiment, the service function processing unit 45 has a note editing processing unit 51 that performs the above described note editing function of writing a note with respect to the screen image sent from the presenter terminal 10, and a blank sheet processing unit 52 that displays a blank sheet on the screen to permit note writing and the like. The blank sheet processing unit 52 may also be considered as one function in the note editing function. The screen image storage processing unit 46 writes the screen image displayed on a display 42 only shown in FIG. 5 into the saved data temporary memory 50. The saved data temporary memory 50 is provided with respective storage areas 56 and 57 for classifying and registering the screen image sent from the presenter terminal 10 (presenter screen) and the screen image in which the note and the like have been written by the conference participant (note editing screen). The image sending and receiving processing unit 47 receives the screen image sent from the presenter terminal 10. Moreover, the image sending and receiving processing unit 47 sends the screen image displayed on the display 42 to the presenter terminal 10, in response to an instruction by the user. The stored data management unit 49 performs processes with respect to the screen image owned by the conference participant in response to an instruction by the conference participant using his own terminal, such as deleting the screen image which has been saved in the saved data temporary memory 50, sending the screen image to the document management server 30 and the like.

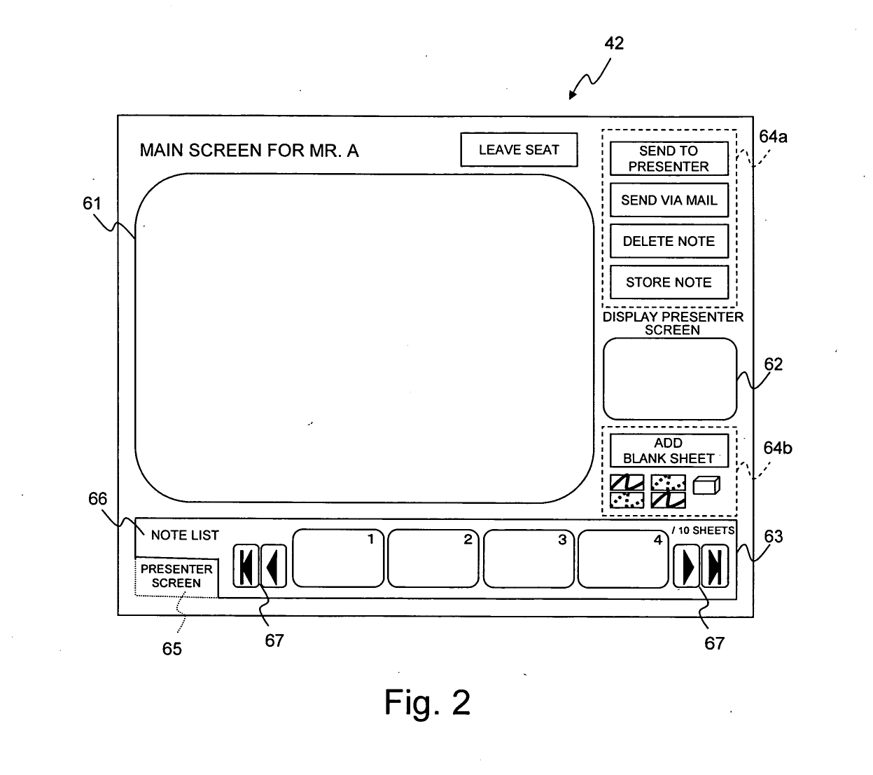

The display controller 48 performs general control of a screen display with respect to the display 42. As shown in FIG. 1, the display controller 48 has a main screen display 53, a sub screen display 54 and a saved screen display 55. FIG. 2 is a diagram showing an example of a screen layout displayed on the display 42. With reference to this figure, the display controller 48 in this exemplary embodiment will be described.

The display 42 of the participant terminal 40 is configured with respective display areas of a main screen 61 and a sub screen 62, a display area for the saved screen image 63, display areas 64a and 64b for a button required for using the service function provided by the participant terminal 40 and the like. The main screen display 53 controls displaying on the main screen 61. On the main screen 61, the screen image sent from the above described presenter terminal 10 is displayed. Moreover, the main screen 61 also becomes a working area for the note editing. On the sub screen 62, the screen image sent from the presenter terminal 10 is displayed when the main screen 61 is in a still image state for the note writing. In the saved data display area 63, the screen images saved in the saved data temporary memory 50 are sorted in chronological order and displayed as thumbnails. In this exemplary embodiment, although the presenter screen and the note editing screen are saved in the different storage areas 56 and 57 respectively, either of these screen image groups stored in the storage areas 56 and 57 is displayed switchably by selecting either a presenter screen tab 65 or a note list selection tab 66.

The display area 64a for providing the service function is provided with various buttons of “Send to presenter”, “Send mail”, “Delete note” and “Store note”, and in the display area 64b, GUI parts required for performing a blank sheet process, such as an “Add blank sheet” button and the like, are displayed. It should be noted that each service function will be described in conjunction with operation of this exemplary embodiment.

Processing functions in the above described respective units 43 to 49 in the participant terminal 40 are realized with collaborative operation of a computer constituting the participant terminal 40 and an electronic conference assistance program which operates with a CPU provided in the computer.

In this application, as may also be understood from the above described system configuration, the electronic conference system is not necessarily limited to a conference conducted by connecting remote locations, and collectively refers to conferences conducted by using the computers such as the presenter terminal 10, the participant terminal 40 and the like. This exemplary embodiment is preferable for incorporating and performing the processing functions as described below in Interactive Wall (registered trademark) produced by Fuji Xerox Co., Ltd., which has already been commercially available as an electronic conference system, for example, and this exemplary embodiment will be described, with a touch panel display device assumed as the touch panel display device 12 in the presenter terminal 10.

Hereinafter, a process from starting the electronic conference until the conference participant stores a desired screen image in a predetermined storage location during the electronic conference, using the electronic conference system in this exemplary embodiment, will be described.

First, the process until participating in the conference remains the same as the related art. In other words, when the conference participant sits in a predetermined seat in a conference room, and has his own IC card read by an IC card reader 41 in order to log into the system and participate in the electronic conference, the user authentication unit 43 sends a user ID of the participant read by the IC card reader 41 to the user management server 20, and queries an attribute of the IC card owner. The information management unit 22 in the user management server 20 authenticates the user by confirming that the conference participant matches with the sent user ID, and returns a result of the authentication to the user authentication unit 43. Moreover, the information management unit 22 updates the information on the user and the like, such as the conference in which the user is participating and the like, if necessary. When the user is authenticated by the user authentication unit 43, the user information acquisition processing unit 44 acquires the user information on the participant from the user management server 20. In this exemplary embodiment, the user information acquisition processing unit 44 may acquire at least the storage location of the screen image managed by the participant. Specifically, the user information acquisition processing unit 44 acquires a URL for identifying the storage location (repository) in the document management server 30. As described above, the participant may participate in the conference.

The conference is started and the presenter of the conference may proceed with the conference using the presenter terminal 10. The screen image displayed on the touch panel display device 12 of the presenter terminal 10 is displayed on the display 42 of the participant terminal 40, and when the screen image displayed on the touch panel display device 12 is changed, display contents on the display 42 of each participant terminal 40 is changed in real time with the changed screen image. Although a basic operation of the screen display remains the same as the related art, a process for acquiring the screen image for updating the display on the display 42 will be described in detail.

Each participant terminal 40 queries the presenter terminal 10 periodically, for example, at an interval of one second, as to whether or not there is updating of the display on the touch panel display device 12. Each time a new screen image is generated and displayed, the presenter terminal 10 allocates a screen ID to the screen image, and replies with the screen ID of a currently displayed screen image with respect to the query from each participant terminal 40. Each participant terminal 40 compares the screen ID returned from the presenter terminal 10 and the screen ID of the screen image currently displayed on the main screen 61, and if these screen IDs are not identical, each participant terminal 40 determines that the new screen image has been displayed on the presenter terminal 10, and acquires the most recent screen image displayed on the presenter terminal 10 with its screen ID. It should be noted that the display controller 48 displays this acquired screen image on the main screen or the sub screen.

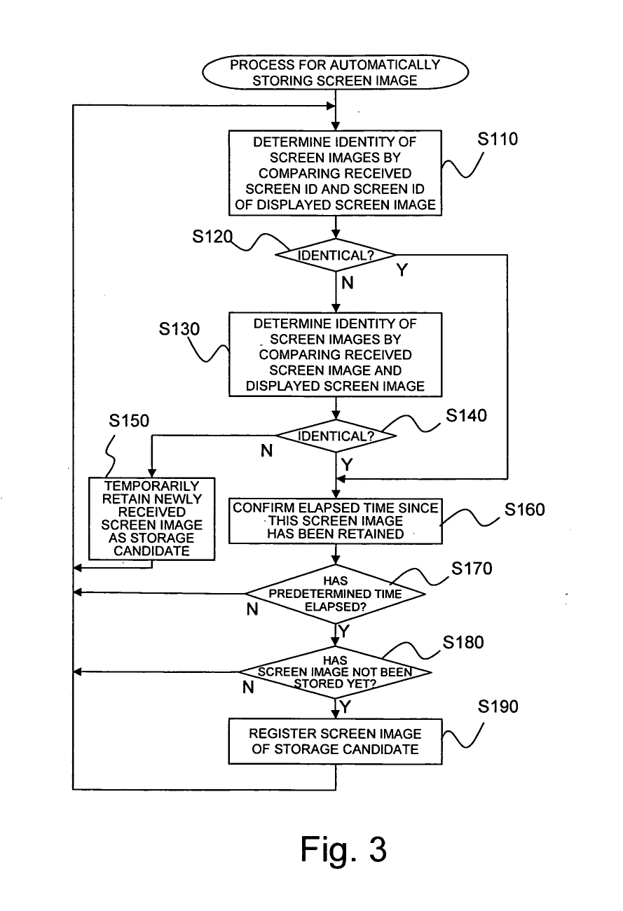

Next, a process for automatically storing the screen image, which is characteristic of this exemplary embodiment, will be described with a flow chart shown in FIG. 3.

The screen image storage processing unit 46 compares the screen ID acquired from the presenter terminal 10 in the above described screen image acquisition process, and the screen ID of the screen image currently displayed on the display 42, and determines an identity between these screen images (step 110). If these screen IDs are identical (Y at step 120), the process proceeds to step 160. This process will be described below. If these screen IDs are different, the screen image storage processing unit 46 compares the screen image acquired from the presenter terminal 10 in the above described screen image acquisition process, and the screen image displayed on the display 42, and determines the identity between these screen images (step 130). Detailed contents of this process for determining the identity will be described below. Here, if it is determined that these screen images are not identical, because the screen image displayed on the touch panel display device 12 has been updated by writing into the screen image displayed on the touch panel display device 12, or by switching the screen image to be displayed on the touch panel display device 12 and the like by the presenter, the received screen image is only temporarily retained as a storage candidate at a time like this (step 150).

On the other hand, if it is determined that these screen images are identical (Y at step 140), it may be considered that the screen image displayed on the touch panel display device 12 is to be maintained, similarly to the case of determining the screen images to be identical in the above described comparison of the screen IDs. In this case, an elapsed time since the screen image has been temporarily retained is confirmed (step 160). Here, if the screen image has been retained for a preset predetermined time, in other words, if it is determined that the screen image has been displayed continuously on the touch panel display device 12 of the presenter terminal 10 for the predetermined time (Y at step 170), and if the screen image has not been stored (Y at step 180), the screen image storage processing unit 46 writes and registers the screen image in the presenter screen storage area 56 of the saved data temporary memory 50 (step 190). It should be noted that if the predetermined time has not elapsed at step 170, the writing into the saved data temporary memory 50 is not performed. This corresponds to, for example, a state in which movement of a pen has been stopped in the middle of writing the note on the screen image. Moreover, if the screen image has already been stored in the saved data temporary memory 50 at step 180, since it is not necessary to store the screen image again, the screen image is also not stored in this case.

For example, if the above described predetermined time is set to five seconds, when the screen display on the touch panel display device 12 has been maintained for five seconds, the screen image storage processing unit 46 stores the screen image by writing the screen image in the saved data temporary memory 50. On the other hand, if the screen display on the touch panel display device 12 has been changed, or if the screen display on the touch panel display device 12 has not been changed but five seconds have not elapsed since the screen image has been displayed, the screen image is not stored.

Next, the storage of the screen image when the conference participant is writing the note and the like in the screen image displayed on the display 42, using the note editing function, will be described.

As the screen image to be stored when the participant is performing the note editing, there are a screen image which is currently displayed on the main screen 61 and is a target of the note editing, and a screen image which has been received from the presenter terminal 10. It should be noted that the former is displayed on the main screen 61 of the display 42, and the latter is displayed on the sub screen 62 of the display 42, during the note editing.

The basic concept of a process for storing the screen image of the target of the note editing is the same as that of the above described process for automatically storing the screen image displayed on the touch panel display device 12. In other words, the note editing processing unit 51 determines whether or not there is updating of the screen image, by comparing the currently displayed screen image and the temporarily retained screen image. That is, if the note editing processing unit 51 determines that the participant is in the middle of writing the note in the displayed screen image since these screen images are not identical, the note editing processing unit 51 only temporarily retains the currently displayed screen image. On the other hand, if these screen images are identical and that state has continued for the predetermined time, the note editing processing unit 51 determines that the job of note editing by the participant has been terminated in this case, and writes the screen image displayed on the main screen 61 at that point in time in the saved data temporary memory 50. It should be noted that the storage location of this screen image is the note editing screen storage area 57.

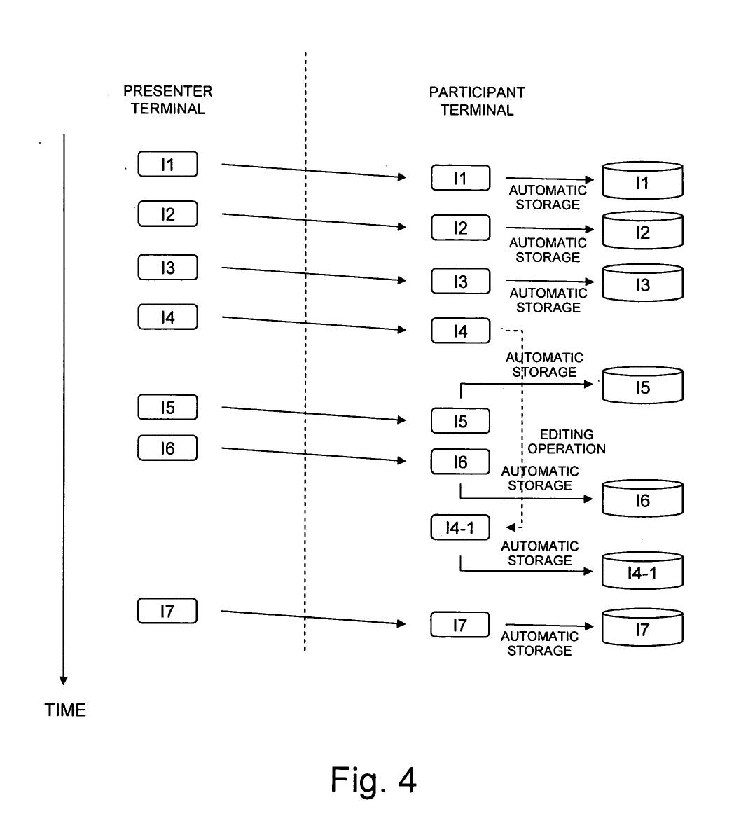

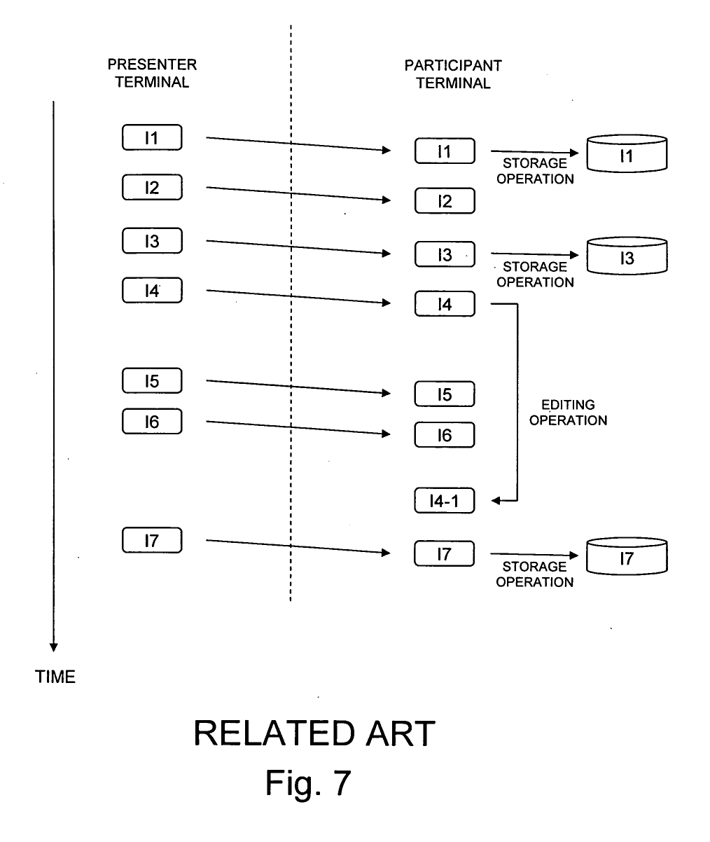

By the way, the new screen image may also be sent from the presenter terminal 10 even during the note editing. In this case, with the above described automatic storage function performed by the screen image storage processing unit 46, the screen image sent from the presenter terminal 10 is automatically stored in the presenter screen storage area 56 of the saved data temporary memory 50. FIG. 4 is a conceptual diagram showing handling of the screen images in this exemplary embodiment. In the related art, it has not been possible to store the screen images I5 and I6 which have been sent during the note editing as shown in FIG. 7. However, in this exemplary embodiment, with the above described process for automatically storing the screen image, it is possible to store the screen images I5 and I6 without interrupting the note editing process with respect to the screen image I4.

Moreover, such a case may also be considered where the participant hopes to immediately refer to the screen image sent from the presenter terminal 10, seeing the display on the sub screen 62. That is, a case where the participant hopes to switch to displaying the presenter screen on the main screen 61. In such a case, for example, a display switching button has been provided, and when this display switching button is depressed, the note editing is forcibly terminated and concurrently the screen image for which the note editing was being performed is written in the saved data temporary memory 50. Then, the display on the main screen 61 is switched to the screen image sent from the presenter terminal 10.

It should be noted that it is possible to restart the editing with respect to the note editing screen image which has been forcibly terminated and stored, in this exemplary embodiment. If the conference participant hopes to restart the note editing, the conference participant selects the note list selection tab 66 in the screen image display area 63, and furthermore, operates a scroll button 67 if necessary to select the desired screen image. The display controller 48 displays the selected screen image on the main screen 61, in response to this user operation. By displaying the screen image on the main screen 61 in this way, it is possible for the conference participant to restart the note editing with respect to the selected screen image. It should be noted that, although the screen image which has been edited again is stored with an automatic termination of the note editing function due to the elapse of the predetermined time or by depressing the Store note button by the conference participant, the screen image displayed again on the main screen 61 may be overwritten and stored, or may be stored separately as a new screen image at this time. Either of these may be employed by the system, or may be selected by the user, by providing a mode switching function.

In this exemplary embodiment, the blank sheet is provided for performing the note editing. The above described note editing function is basically a function of writing the note directly with respect to the screen image displayed on the presenter terminal 10. However, depending on contents to be displayed on the screen, there may not be enough space to write the note. Consequently, it is possible to add the blank sheet in order to provide space for writing the note. When the Add blank sheet button on the display area 64b is depressed, the blank sheet processing unit 52 of the service function processing unit 45 displays the screen image of the blank sheet on the main screen 61. Since the process after that is the same as that of the note editing function, description thereof is omitted. However, if there has not been any writing for the predetermined time, as a result of depressing the Store note button, the blank sheet processing unit 52 writes the screen image displayed on the main screen 61 in the note editing screen storage area 57 of the saved data temporary memory 50. It should be noted that it is also possible to store the screen image sent from the presenter terminal 10 in the presenter screen storage area 56 of the saved data temporary memory 50, with the function of automatically storing the screen image, during the note editing with respect to the blank sheet, as described above.

It should be noted that it is possible to delete the screen image for which the note editing is being performed and the note editing screen image which has been stored. If the conference participant hopes to delete the screen image for which the note editing is being performed, it is possible for the conference participant to delete the screen image by depressing the Delete note button. If the conference participant wants to delete a screen image which has been stored, the conference participant operates similarly to the above described specific restart of the note editing and displays the screen image to be deleted on the main screen 61. Since the note editing screen image displayed on the main screen 61 in this way may be handled similarly to the screen image for which the note editing is being performed, the conference participant depresses the Delete note button in a state where the screen image to be deleted is displayed on the main screen 61. Thereby, the stored data management unit 49 deletes the note editing screen image to be deleted, from the saved data temporary memory 50. In this way, it is also possible to delete a note editing screen which has been stored temporarily.

By the way, in this exemplary embodiment, it is possible to automatically store the screen image sent from the presenter terminal 10, as described above. However, since the screen image is automatically stored according to a predetermined rule when the screen image has not been changed on the presenter terminal 10 for the predetermined time, a screen image which is not actually required by the conference participant may also be stored. Consequently, in this exemplary embodiment, the stored data management unit 49 is provided so that the stored screen image may be deleted during the conference or after the conference has finished. In this process for deleting the screen image, the screen image may be deleted by providing a dedicated screen, for example. It should be noted that this process for deleting the screen image may be performed during the conference or after the conference has finished.

When the electronic conference has finished, the stored data management unit 49 transfers the screen images accumulated in the saved data temporary memory 50 together with the URL of the conference participant, which is information on the storage location, to the document management server 30. The information management unit 32 of the document management server 30 stores the transferred screen images in the specified URL of the conference participant. After the storage is completed normally, the stored data management unit 49 deletes the screen image which has been temporarily stored in the saved data temporary memory 50.

Finally, the determination of the identity between the screen images will be described. In the respective processes of the function of automatically storing the screen image and the note editing function in the participant terminal 40, it has been described that the currently displayed screen image and the temporarily retained screen image are compared, and if it can be determined that the identical screen image has continued to be displayed for the predetermined time, the screen image is stored.

However, even if the identical screen image has continued to be displayed in the presenter terminal 10, in fact, it may be incorrectly recognized that the screen image is not perfectly identical, that is, in the comparison process in the presenter terminal 10 it may be determined that the screen image has been continuously updated, in a similar way to how it would be updated during the note writing, due to signal noise which has occurred during transferring the screen image and the like. In this way, when the signal noise has been mixed with the screen image due to degradation in communication quality and the like, even if the identical screen image has been displayed, it may be incorrectly recognized that the screen image has been changed frequently (before the predetermined time period (5 seconds in the above described example) has elapsed), and as a result, it may also become impossible to store even a single presenter screen during the conference.

Consequently, in this exemplary embodiment, an allowable range for determining as being identical is set for comparison of the screen images.

For example, a value of one pixel included in the screen image received this time is set as P, and a value of a corresponding pixel in the temporarily retained screen image is set as C. A count of the number of times P≠C is accumulated, and if its percentage does not exceed a certain number or a certain ratio with respect to a number of pixels in the entire screen image, the compared screen images are regarded as identical.

Moreover, if there is a case where the screen image is inputted as an analog signal, a process for comparing the pixels and a filtering process are considered as methods of determining the identicalness. In the former case, when the value of one pixel in the screen image received this time is set as P, the value of the corresponding pixel in the temporarily retained screen image is set as C, and a noise margin is set as N, if |P−C|<N is satisfied, these pixels are regarded to have the same value. In the latter case, images which can be acquired by applying a digital noise filter (for example, using DCT (Discrete Cosine Transform) to cut a high spatial frequency domain and the like) with respect to the inputted image signals are compared. For example, when a filter function is set as f, the identity between the screen images is determined by whether or not |f(P)−f(C)|<N is satisfied.

It should be noted that, with respect to thresholds (criterion values) which are set for determining whether or not the screen images are identical, such as a certain number, a certain ratio, a noise margin and the like as described above, it is considered that the criterion values can be set to relatively moderate values, considering that the screen image to be determined as not identical in the electronic conference system is a screen image which is displayed when the display contents are switched or in the middle of the note writing and the like.

Although this exemplary embodiment may provide the function of automatically storing the screen image sent from the presenter terminal 10, it may be configured so that the user can select a mode of either this automatic storage function or the existing manual storage function.

Moreover, in this exemplary embodiment, after the screen images are temporarily stored in the saved data temporary memory 50, and the stored screen images are arranged if necessary, the screen images are collectively sent to the document management server 30 which retains and manages the screen images. However, it may be configured so that the screen images may be written directly in the screen image memory 31 of the document management server 30, not via the saved data temporary memory 50.

Moreover, although this exemplary embodiment has been described with the example of the electronic conference which is held in one conference room, this exemplary embodiment is applicable to the electronic conference which is held by connecting the conference rooms at remote locations via the network.

According to another aspect of the invention, there is provided a computer readable medium storing a program causing a computer used by a conference participant, which receives a screen image displayed on a presenter terminal device and displays the screen image on a screen in an electronic conference, to execute a process for assisting the electronic conference, the process including receiving the screen image sent from the presenter terminal device, and when a screen image which is different from a currently displayed screen image has not been sent from the presenter terminal device within a predetermined time, writing the currently displayed screen image in a memory.

According to another aspect of the invention, there is provided a computer readable medium storing a program causing the computer to execute a process for assisting the electronic conference, the process including when a second screen image which is different from a first screen image which has been temporarily retained is sent from the presenter terminal device, temporarily retaining the second screen image; and when the second screen image which is different from the first screen image is not sent from the presenter terminal device within the predetermined time, writing the first screen image in the memory.

According to another aspect of the invention, there is provided the computer readable medium storing the program causing the computer to execute the process for assisting the electronic conference, the process further including performing a process with respect to a noise of the screen images before determining whether the first screen image and the second screen image are different or not.

According to another aspect of the invention, there is provided the computer readable medium storing the program causing the computer to execute the process for assisting the electronic conference, the process further including editing the received screen image according to an operation by a user, displaying the received screen image being edited on a main display area of the computer while the editing process is being performed, and while the editing process is performed, displaying a newly received screen image on a display area different from the main display area of the computer.

According to another aspect of the invention, there is provided the computer readable medium storing the program causing the computer to execute the process for assisting the electronic conference, the process further including editing the received screen image according to an operation by a user, displaying the received screen image being edited on a main display area of the computer while the editing process is being performed, and after the editing process is performed, writing the edited screen image in the memory.

According to another aspect of the invention, there is provided the computer readable medium storing the program causing the computer to execute the process for assisting the electronic conference, the process further including classifying the received screen image and the edited screen image, and writing them in the memory.

According to another aspect of the invention, there is provided the computer readable medium storing the program causing the computer to execute the process for assisting the electronic conference, the process further including selectively displaying the classified and written screen images on a screen display area of the computer.

According to another aspect of the invention, there is provided the computer readable medium storing the program causing the computer to execute the process for assisting the electronic conference, the process further including deleting a screen image according to a user instruction, from the memory.

According to another aspect of the invention, there is provided a conference participant terminal device included in an electronic conference system that receives a screen image displayed on a presenter terminal device and displays the screen image on a screen in an electronic conference, including a receiving unit that receives the screen image sent from the presenter terminal device, and a storage processing unit that writes a currently displayed screen image in a memory, when a screen image which is different from the currently displayed screen image has not been sent from the presenter terminal device within a predetermined time.

According to another aspect of the invention, there is provided an electronic conference assistance method performed in a computer that receives a screen image displayed on a presenter terminal device and displays the screen image on a screen in an electronic conference, including receiving the screen image sent from the presenter terminal device, and when a screen image which is different from a currently displayed screen image has not been sent from the presenter terminal device within a predetermined time, writing the currently displayed screen image in a memory.

According to an aspect of the invention, when display contents have been maintained for the predetermined time in the presenter terminal device, the screen image is automatically stored. It is therefore possible for the conference participant to store the screen image without being carefully.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic conference system, comprising:
a presenter terminal device that displays on a screen of a presenter display in an electronic conference;
a conference participant terminal device that receives a screen image displayed on the presenter display and displays the screen image on a screen;
a receiving unit that receives the screen image sent from the presenter terminal device; and
a storage processing unit that writes a currently displayed screen image in a memory, when a screen image which is different from the currently displayed screen image has not been sent from the presenter terminal device within a predetermined time.

2. A computer readable medium storing a program causing a computer used by a conference participant, which receives a screen image displayed on a presenter terminal device and displays the screen image on a screen in an electronic conference, to execute a process for assisting the electronic conference, the process comprising:
receiving the screen image sent from the presenter terminal device; and
when a screen image which is different from a currently displayed screen image has not been sent from the presenter terminal device with in a predetermined time, writing the currently displayed screen image in a memory.

3. The computer readable medium according to claim 2, the process further comprising:
when a second screen image which is different from a first screen image which has been temporarily retained is sent from the presenter terminal device, temporarily retaining the second screen image; and
when the second screen image which is different from the first screen image is not sent from the presenter terminal device within the predetermined time, writing the first screen image in the memory.

4. The computer readable medium according to claim 3, the process further comprising:
performing a process with respect to a noise of the screen images before determining whether the first screen image and the second screen image are different or not.

5. The computer readable medium according to claim 3, the process further comprising:
editing the received screen image according to an operation by a user;
displaying the received screen image being edited on a main display area of the computer while the editing process is being performed; and
while the editing process is performed, displaying a newly received screen image on a display area different from the main display area of the computer.

6. The computer readable medium according to claim 2, the process further comprising:
editing the received screen image according to an operation by a user;
displaying the received screen image being edited on a main display area of the computer while the editing process is being performed; and
after the editing process is performed, writing the edited screen image in the memory.

7. The computer readable medium according to claim 2the process further comprising:
classifying the received screen image and the edited screen image, and writing them in the memory.

8. The computer readable medium according to claim 7, the process further comprising:
selectively displaying the classified and written screen images on a screen display area of the computer.

9. The computer readable medium according to claim 2, the process further comprising:
deleting a screen image according to a user instruction, from the memory.

10. A conference participant terminal device included in an electronic conference system that receives a screen image displayed on a presenter terminal device and displays the screen image on a screen in an electronic conference, comprising:
a receiving unit that receives the screen image sent from the presenter terminal device; and
a storage processing unit that writes a currently displayed screen image in a memory, when a screen image which is different from the currently displayed screen image has not been sent from the presenter terminal device within a predetermined time.

11. An electronic conference assistance method performed in a computer that receives a screen image displayed on a presenter terminal device and displays the screen image on a screen in an electronic conference, comprising:
receiving the screen image sent from the presenter terminal device; and
when a screen image which is different from a currently displayed screen image has not been sent from the presenter terminal device with in a predetermined time, writing the currently displayed screen image in a memory.

12. A computer data signal embodied in a carrier wave for enabling a computer used by a conference participant, which receives a screen image displayed on a presenter terminal device and displays the screen image on a screen in an electronic conference, to perform a process for assisting the electronic conference, the process comprising:
receiving the screen image sent from the presenter terminal device; and
when a screen image which is different from a currently displayed screen image has not been sent from the presenter terminal device within a predetermined time, writing the currently displayed screen image in a memory.
